(19) United States
(12) Patent Application Publication
(10) Pub. No.: US 2023/0208344 A1
(43) Pub. Date: Jun. 29, 2023

(54) OPTIMALLY-PLACED, WALL-MOUNTED SOLAR DEVICE

(71) Applicant: JOSEFINA CRUZ, NEW YORK, NY (US)

(72) Inventor: JOSEFINA CRUZ, NEW YORK, NY (US)

(21) Appl. No.: 17/936,116

(22) Filed: Sep. 28, 2022

Related U.S. Application Data
(60) Provisional application No. 63/361,427, filed on Dec. 24, 2021.

(51) Int. Cl. H02S 20/22

(52) U.S. Cl. CPC H02S 20/22; H02S 20/23

(57) ABSTRACT

An Optimally-Placed Wall-Mounted Solar Device is a photovoltaic canopy system comprised of a metal framework that would be attached to the exterior walls of a building and used to support a plurality of accurately-emplaced photovoltaic panels, to optimize the collection of solar energy “at all times of the day and all seasons of the year”. On a yearly basis, the sun visibly charts its path on buildings in 40° NL. Winter and summer solstice day arcs plus peak hours of optimum solar energy (i.e., the boundaries of the imaginary quadrilateral ancient astronomers called SOLAR WINDOW) form an arched configuration for emplacement of the PV panels. Furthermore, PV panels hosting the sun disc could:
(i) Convert the Sun’s electromagnetic radiation into a usable continuous voltage (DC);
(ii) Turn sun discs into modern versions of pinhole cameras; and
(iii) Help document orbital and rotational changes in the Earth’s angle from within the planet, independent of sensors onboard satellites.

### FIELD OF INVENTION

Like U.S. Provisional Pat. Application No. 63/361,427, filed on Dec. 24, 2021 (for which a domestic benefit claim is herein being made), the present Utility Patent Application relates to conventional solar panels that work at an efficiency of 15 to 20 percent, with a theoretical maximum of 32%.

From its inception, industry experts have set solar technology for horizontal installation. In the US, the optimal installation or most efficient PV array location for a maximum production of 20% is horizontal panels perpendicular to the sun (i.e., facing directly south, towards the equator). To make solar panels more efficient, a tilt angle was at some point incorporated. Available at https://understandsolar.com/vertical-solar-panels/ and https://www.e-education.psu.edu/eme810/node/534. The tilt angle, an average of the highest and the lowest heights of the sun throughout the year for a specific location, is identical to the equinox angle, the point at which the Earth’s orbit touches the celestial equator.

Claims have also been made by experts that vertical solar panels, based on their low efficiency, do not make financial sense. Id.

### BACKGROUND

More than two thousand years ago, astronomers started applying sundials and place-related sun positions to create thoughtful architectural designs in their horizontal towns. Available at https://doi.org/10.1080/00038628.2004.9697037. Using sunlight when needed for heat and natural light and deflecting its power at other times are two of the most critical tasks in building design. It took astronomers longer than a century to come up with the traditional analemma rules and the descriptive geometry principles and concepts, which were – and are – the tools for plotting sun path projections, digital or not. Projecting altitude and azimuth values outward onto a surrounding cylinder which was subsequently opened onto a flat, horizontal surface, ancient astronomers were able to create comfortable indoor environments for different seasons and to achieve maximum productivity for plant growth, among other accomplishments.

How much more expeditious could the above protracted endeavor have been if ancient astronomers had been able to track the path of the sun from the beginning, not dashing across the sky – an optical illusion – but scaling walls a few feet above ground level, as is visible today to the naked eye of scientifically-informed observers in 40° NL.

Throughout history, the sun path chart with seven arcs representing the 12 months of the year (FIG. 1) proved to be a great tool. Ancient astronomers called SOLAR WINDOW the imaginary quadrilateral- according to them in the dome of the sky - whose boundaries were the following “lines”:

a. Winter solstice (the lowest arc) falls every year on December 21st.

b. Summer solstice (the highest arc) falls every year on June 21st.

c. 9 a.m. (the starting point of peak optimum solar energy every day of the year).

d. 3 p.m. (the end of peak optimum solar energy every day of the year).

Throughout the year, the height of each arc of electromagnetic radiation (FIG. 2) reflects seasonal changes in the earth’s angle. In addition, as the sun runs its course towards noon in the morning and then south, the dotted lines on the orthographic projection cover the peak hours when the sun is available for maximum collection of electromagnetic radiation in a particular location.

The horizontal installation of photovoltaic panels was built upon the undeniable success of the sun path charts of the past. The pyranometer, invented to measure the power of electromagnetic radiation in the first decade that solar was in existence but was not even a fledgling industry yet, reinforced that collecting surfaces had to be horizontal. The 15-to 20-percent efficiency of conventional panels is the result of this horizontal installation, by default. Having been around for a little less than 150 years and set for horizontal installation, the industry is presently unable to migrate to better tooling solutions to improve its efficiency and aesthetics, while it is still searching for viable and affordable energy solutions.

After air conditioning allowed the construction of our paradigms of modem architecture starting in 1949, window walls with spectrally-selective coatings have been turning into shiny, (one-way) mirror-like surfaces when the sun strikes them, the smooth surfaces simultaneously capturing successive, ephemeral replicas of the motionless, distant sun. FIG. 3 also means that, since around the middle of the 20^{th} C., the naked eyes of scientifically-informed observers should have seen – but did not see – that the sun visibly charts its own day arc in 40° NL, and that it is easier to track the boundaries of the SOLAR WINDOW, albeit invisible, on the walls of buildings, for maximum exposure of solar cells. Nevertheless, proponents of solar technology continue to basically project the imaginary quadrilateral in the dome of the sky onto rooftops, even while environmental stewardship within the context of a new, unrelenting climate crisis now clamors for faster de-carbonization in the interest of sustainable development in our planet.

Accurate emplacement is the new tooling solution, the ultimate sun-related positioning for the photovoltaic industry in a new landscape.

In addition, the following amongst other wide-range industrial applications could derive from accurate emplacement:

I. When available, photographs are invaluable astronomical research tools that offer cogency, more accurate than the equations and diagrams astronomers use to prove their theories and dispute their claims. Better yet, snapshots are geo-tagged, which means they come with useful background information. In this regard, satellite-based sensors collect data to support theoretical calculations of how magnitude 6 and higher earthquakes (like the magnitude 9.0 Mar. 11, 2011 Japan earthquake) affect Earth’s rotation and shift the figure axis that, in turn, changes the planet’s yearly Equinox wobbles. Although no theoretical calculations into the orbital effects of earthquakes are possible using sensors, comparing snapshots of geo-tagged landmarks could provide solid evidence of deviations in seasonal angles, temporary or not, when they occur.

II. Accurate emplacement could contribute to the expansion of RF energy harvesting that converts electromagnetic radiation into a usable continuous voltage or DC as well as explore how this research can increase the efficiency of PV panels.

III. Finally, for centuries before the invention of special telescopes, scientists studied the 11-year cycle of the Sun (inter alia, solar flares, sunspots and Solar Maximums) through pinholes. Window walls capturing the sun disc can have a great appeal as generally safe, natural alternatives to pinhole cameras, in lieu of expensive telescopes, for both educational and recreational purposes. Solar filters might be needed, and sun glasses are recommended.

The blazing trail of the sun (FIG. 3) on a 40° NL wall is ephemeral: The sighting of a sun disc lasts ten or twelve minutes on each floor; then with a rotational oblique motion (i.e., diagonally, counterclockwise) the disc climbs to the next higher window. As the earth rotates 15° every hour and the skyscrapers with it (one degree or 15 arc minutes every four minutes), the sun pinpoints with precision, as a corollary, the accurate emplacement of customizable, lightweight photovoltaic (PV) panels which can be affixed onto the concrete/masonry of the exterior walls of buildings for maximum exposure of the solar cells in the panels to the sun “at all times of the day and all seasons of the year”. Available at https://www.smithsonianmag.com/sponsored/brief-history-solar-panels-1809720061 (Specifications of U.S. Pat. No. 527379).

Four hundred years after fierce debates regarding whether the earth rotates on its axis or if – like other planets – it orbits the sun, the sun steps to the plate and allows its pyrotechnics to impart knowledge which is essential for buildings on earth to create their own clean energy, while simultaneously undoing the illusion of the sun’s daily race across the sky, and even - perhaps - proving and settling for good, from inside the planet, post pendulum, the no longer relevant question of the earth’s rotation.

With regards to environmental stewardship for sustainable development in our planet, besides supporting climate mitigation and helping minimize the need for conventional natural resources in the energy market, accurately-emplaced solar panels would make financial sense and could outperform the max production of conventional – rooftop –solar panels, thus contributing to the transformation of the photovoltaic industry. In addition, de-carbonized residential and commercial buildings outfitted with accurately-emplaced solar panels could create enough renewable energy to become zero-energy, lower their operating/maintenance costs, increase the energy resiliency during power outages, and achieve carbon neutrality or at least partial independence from the grid. Finally, with minor additions, a panel hosting the sun disc could harness the maximum incoming electromagnetic radiation and convert it into a usable continuous voltage (DC).

### SUMMARY

Conventional rooftop solar panels do not utilize solar energy fully nor take full advantage of the power of the sun. In fact, an NREL PV Watts solar calculator reveals that the actual efficiency of vertical solar panels compared to the efficiency of horizontal solar panels is the optimal previously described as 20% (not the theoretical maximum), minus 30% to 40%. Available at https://understandsolar.com/vertical-solar-panels/. Minus 4 or 4.8 percent means that vertical solar panels not installed on the path of electromagnetic radiation currently work at an efficiency of around 16% or 15.2%.

According to the Solar Energy Industries Association, in the last decade before the Corona virus pandemic, solar had had an average annual growth rate of 50 percent in the United States, largely due to the Solar Investment Tax Credit enacted in 2006. Installing solar also became more affordable due to a 70 percent drop in installation costs during the same period. Large-scale adoption of solar energy has not occurred anywhere in the world yet, but after the passage of the Inflation Reduction Act with a 10-year tax credit for clean energy, the US is finally in a position to perhaps begin walking in that direction.

With the improvements that an Optimally-Placed, Wall-Mounted Solar Device like the present application describes could provide, accurately-emplaced (vertical) solar panels could soon outperform conventional rooftop solar panels. With optimized efficiency, accurately-emplaced panels could be a turning point in the transformation of the photovoltaic industry.

Densely-populated urban areas have tall buildings with ample, unused south-facing walls for accurately-emplaced solar panels in solar windows that can now be tracked, instead of miles of horizontal rooftop space not capable of fully utilizing electromagnetic radiation.

### BRIEF DESCRIPTION OF THE DRAWINGS

Six drawings are provided to explain the present application, as follows:

FIG. 1 is a sun path chart plotted onto an orthographic (rectangular) projection.

FIG. 2 is the invisible SOLAR WINDOW wrapped around actual buildings in 40° NL.

FIG. 3 captures the sun charting its own path on a window wall in New York City.

FIG. 4 shows the metal framework of the canopy system for accurate emplacement.

FIG. 5 is a battery to collect the DC power output.

FIG. 6 is a DC to AC converter.

### DETAILED DESCRIPTION

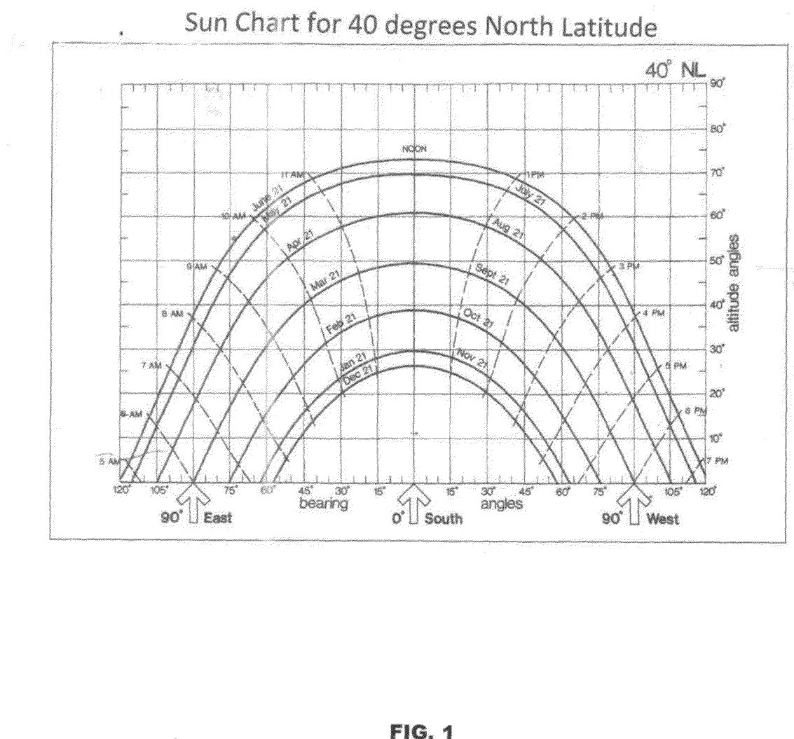

FIG. 1 is an orthographic projection of a sun path chart showing that the path of the sun, a.k.a. day arc, shifts throughout the calendar year, from the winter solstice (a - the lowest arc) to the summer solstice (b - the highest arc). These two day arcs – six months apart –are opposite sides of what ancient astronomers called SOLAR WINDOW and imagined as a quadrilateral on the dome of the sky. The two other parallel sides are dotted lines connected to 12 noon or midday. Noon or midday describes the point in the day arc when peak optimum solar energy is available for collection. Max production is extended for practical reasons to three hours before (c - 9 a.m.) and three hours after (d - 3 p.m.) Available at https:// www.permaculturenews.org/2015/10/23/charting-the-suns-motion-in-relation-to-your-home-and-permaculture-site/. Six hours represent 360 minutes or 90° of the 360° day arc.

On a building facing north with an at least partially unobstructed eastern exposure, flipping the sun path chart from left to right, 9 a.m. is connected to sunrise or the early hours of the morning, in the east (the right); 3 p.m. is connected to sunset or late afternoon, in the west (the left), in a counterclockwise direction. The arc called (e) equinox is related to the tilt angle added to make conventional solar panels more efficient (see page 1).

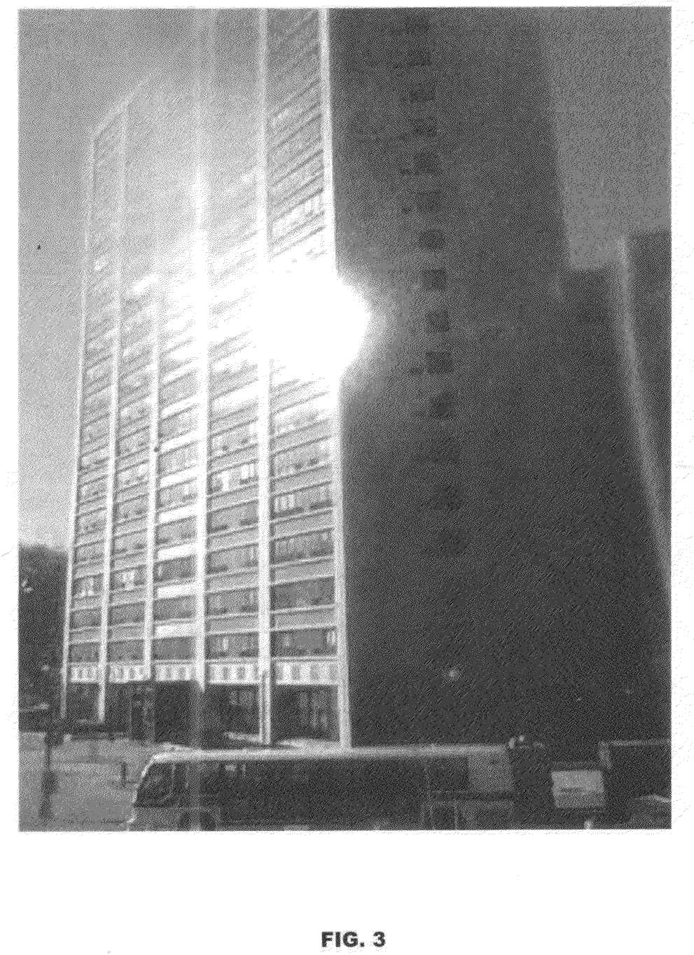

N.B.: FIG. 3 (below) provides visual evidence for the benefit of scientifically-informed observers in 40° NL.

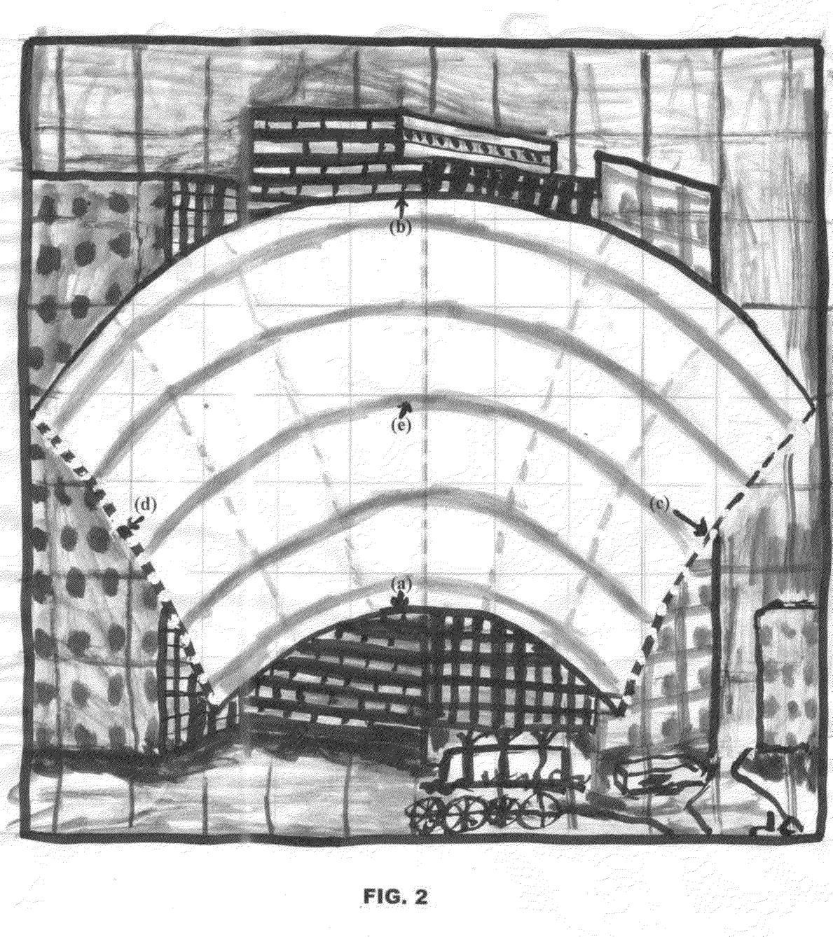

In FIG. 2, the sun path chart, albeit invisible, wraps around the walls of buildings in real time. In a building’s portion of the SOLAR WINDOW, customizable lightweight photovoltaic (PV) panels could be accurately emplaced onto the concrete/masonry of exterior walls, for maximum exposure of the solar cells in the panels to the sun “at all times of the day and all seasons of the year”.

FIG. 3 is a snapshot of a New York City high riser, in latitude 40.7128° N., with at least a partially-unobstructed eastern exposure. In the early morning, the building is flooded by sunlight while the Earth is in orbit around the same Sun. The reflective finish in the window wall has turned glass into a one-way, mirror-like surface that captures a miniature motionless Sun that in 8 minutes must travel 93 million miles or 150 million kilometers, in absolute darkness. Upon entering the earth’s atmosphere, light scatters and becomes visible in the dome of the sky; but its journey does not end until it hits a wall and, as the Earth spins, begins to chart its own path as a day arc that marks solstices and equinoxes vertically and the hours of the day horizontally, without leaving a trace. A photomontage could connect successive dots of sunlight now travelling sideways, to visually display at least a portion of a blazing day arc.

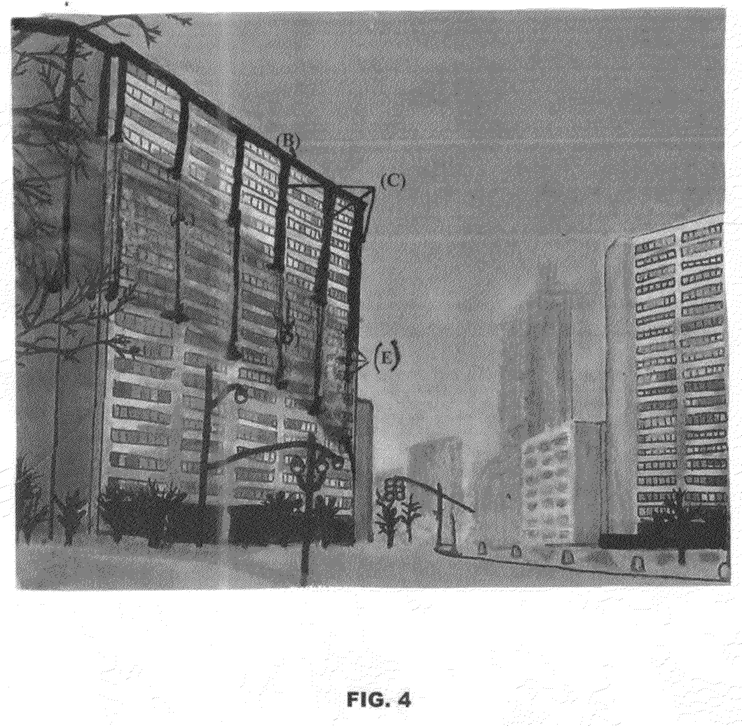

FIG. 4 shows the metal (aluminum or steel) components of the optimally-placed, wall-mounted solar device - a photovoltaic canopy system comprised of (B) a stainless steel bar affixed at the rooftop level and (C) rods/grills suspended from it running down the concrete/masonry to hold at the end one PV panel (D) accurately emplaced within the building’s portion of the SOLAR WINDOW (A) to convert sunlight to DC electricity/power, without blocking vision of individuals within the residential or commercial building where the system is employed.

The PV panels would have layers of glass and an anti-reflective coating, a grid with negative and positive contacts, a silicon semiconductor containing N-type SI and P-type SI, energy harvesting capabilities, and a backing layer with potential insulation (if any). Throughout the day, the glass-top of solar cells or semiconductor silicon with negative and positive charges would harness energy when photons from the sunlight (especially the red and near infrared portion of the spectrum) hit it. The photons would energize the electrons of the semiconductor, causing electric current to flow. Photovoltaic technology would at this point convert photons to DC electricity/power right in the PV panel. However, when at specific times, as per calculations regarding the SOLAR WINDOW, specific panels host the sun disc, the energy harvesting capabilities of the panel would convert the electromagnetic radiation into a usable continuous voltage (DC), harnessing the maximum possible energy from the glare and direct impact.

Finally, for (E) optional solar “window treatments”, see the appropriate paragraph in the pages that follow.

The metal components could be produced through CNC computerized processes such as cutting/water jet or plasma laser, CNC routing, robotic machinery or extrusion for part consistency. Certain components could also be produced through drop-forged or die-casting processes. Secondary production methods could include shearing, stamping, welding, brake-forming, de-burring, drilling, filing and sanding. Different-size panels would be custom built to accommodate specific variables inherent to the requirements and aesthetic preferences of each site.

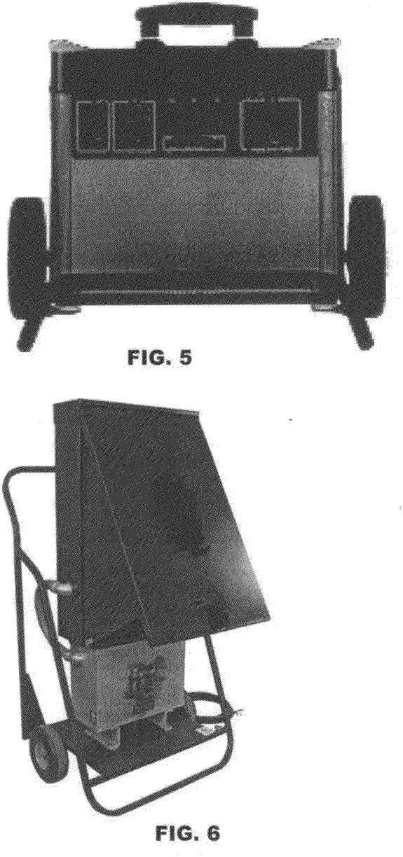

Connected to the battery (FIG. 5) on the floor of the ceiling of the building or at another convenient location, grills/rods would have a concave center to protect the wires that carry the DC power output, which the battery collects.

All solar panels and related solar technology componentry could be produced through conventional methods of glass panel layering/laminating. The components of energy harvesting could be produced by companies engaged in the research, development, production and marketing of devices in this field. The wires, including negative and positive contacts, diodes, fuses, surge protectors, insulation, lights and cables that deliver power could be custom built or made of standard electrical items.

Windows in the SOLAR WINDOW area could have panes made from thin-film cadmium telluride (CdTe) or similar semiconductor, encapsulated between two sheets of heat-strengthened glass, to function as solar collectors/concentrators. Contractors could also upgrade to solar windows by applying lightweight transparent but not entirely clear photovoltaic film to existing windows.

Alternatively, existing windows could be retrofitted with photovoltaic clear glass with invisible wires that would collect energy from the glass. If visible, solar cells would not block the view, as the human eye skips over the cells when looking out the window.

FIG. 5 is the battery collecting the DC power output carried by the wires encased in plastic in the concave center of the grills/rods supporting each PV panel or from the matching windows in the perimeter of arched configuration.

FIG. 6 is a DC to AC converter. The technology for the inverter should be chosen wisely for higher production, greater reliability, and unmatched intelligence.

Any additional required hardware, including recommended battery cell power storage, fasteners or brackets could be designed during manufacturing or made of standard items.

A powder coated paint finish could be used for final color, and required for any raw steel part. An anodizing metal finish could be used for all aluminum parts. All exterior components could include ultraviolet (UV) inhibitors to resist fading and cracking over time due to prolonged water and sunlight exposure.

Plastic components, if any, could be made through the injection-molded or extrusion processes in a variety of hard plastics, including a thermoplastic polymer such as ABS, a recycled composite material, or a high density polyethylene (HDPE). Colors could be included in this manufacturing molding procedure.

Other materials and manufacturing processes could also be considered for this product.

A distribution mechanism with grid-tie (for residential buildings) or off-grid (for commercial buildings) would be installed.

Prior to installation of the system, assistance would be made available regarding strategies to optimize the energy efficiency of the building, and to reduce its heating and cooling loads/bills in a cost efficient manner. Tax incentives and potential grants could be explored.

The invention could be designed, engineered and manufactured similar to products/components having functional and material specifications to meet or comply with all applicable sections of the electrical and building codes and national and international recognized testing laboratories to include: American National Electric Code (NEC), Underwriters Laboratories (UL), European (CE), OSHA®, (Occupational Safety and Health Administration), ETL™ Listed Intertek (ETL), Societe Anonyme - Brands of the World™ (SA), and/or ANSI™ (American National Standards Institute) approval/certifications.

1. The present optimally-placed, wall-mounted solar device would be designed, engineered and manufactured to maximize the exposure of solar cells to the sun and increase the overall efficiency of solar panels by tracking the path of the Sun on the exterior walls of buildings.

2. Harvesting the maximum electromagnetic radiation for wider use could be significantly improved for the purpose of converting it into a usable continuous voltage (DC).

3. The orbital and rotational effects of earthquakes magnitude 6.0 and higher could be studied by comparing geo-tagged snapshots of selected landmarks.
